(19) United States
(12) Patent Application Publication
(10) Pub. No.: US 2005/0156757 A1
(43) Pub. Date: Jul. 21, 2005

(54) Red light violation prevention and collision avoidance system

(76) Inventor: Michael Lynn Garner, Gray, TN (US)

Correspondence Address: Michael L. Garner, 122 Hillrise Road, Gray, TN, 37615, US

(21) Appl. No.: 11/038,734

(22) Filed: Jan. 20, 2005

Related U.S. Application Data
(60) Provisional application No. 60/537,596, filed on Jan. 20, 2004.

(51) Int. Cl. G08G 1/095

(52) U.S. Cl. 340/907

(57) ABSTRACT

A system, self-contained operational entity, that provides vehicle approach speed monitoring, for at least one lane leading to a red light of a signal-controlled roadway intersection, to measure vehicle deceleration rate approaching said red light and methods of warning, visually and audibly, for at least one lane leading to said light of said intersection, to gain vehicle operator's attention to prevent intentional and/or unintentional red light violations at said intersection. Said system, utilized in groups of at least two, also avoids collisions within said intersection due to said violations by warning, visually and audibly, to vehicle operators receiving a green light at same said opposing intersection to slow immediately and look for possible vehicle running red light against their traffic flow and if clear proceed normally.

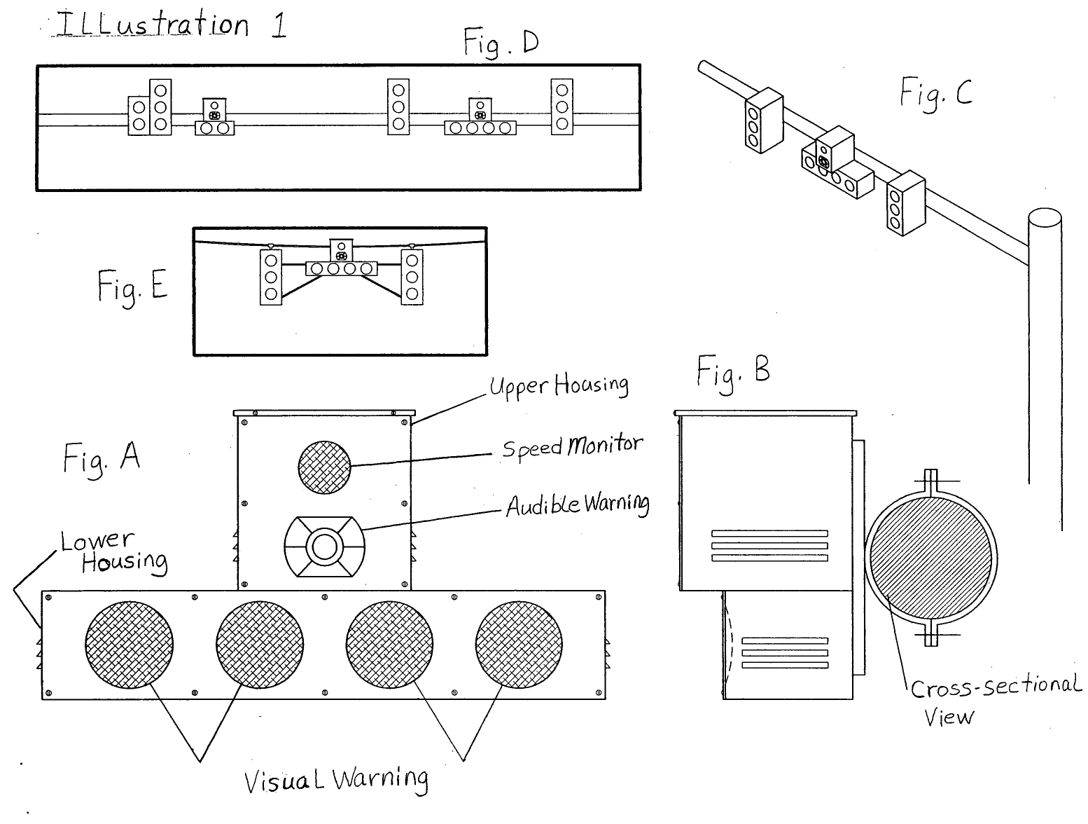

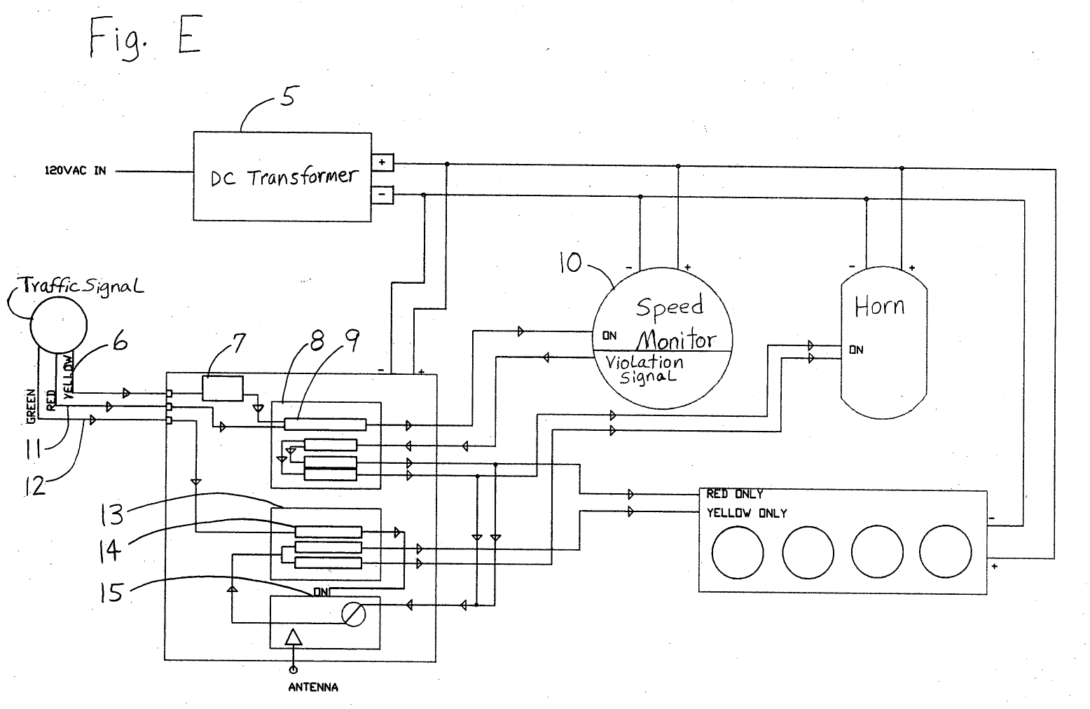

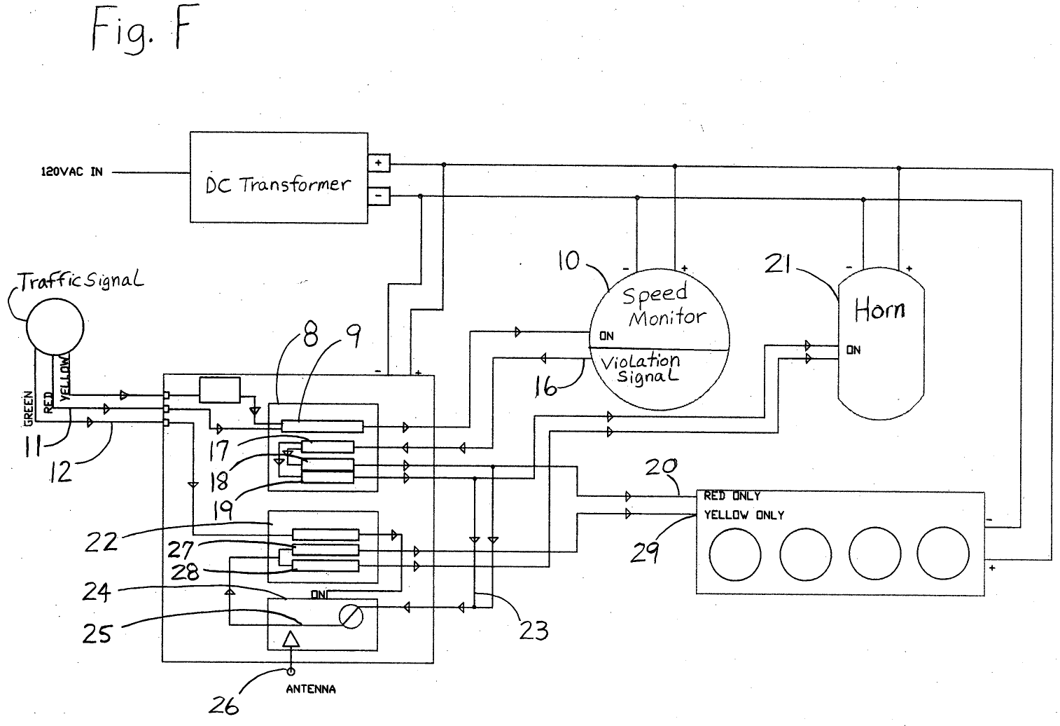

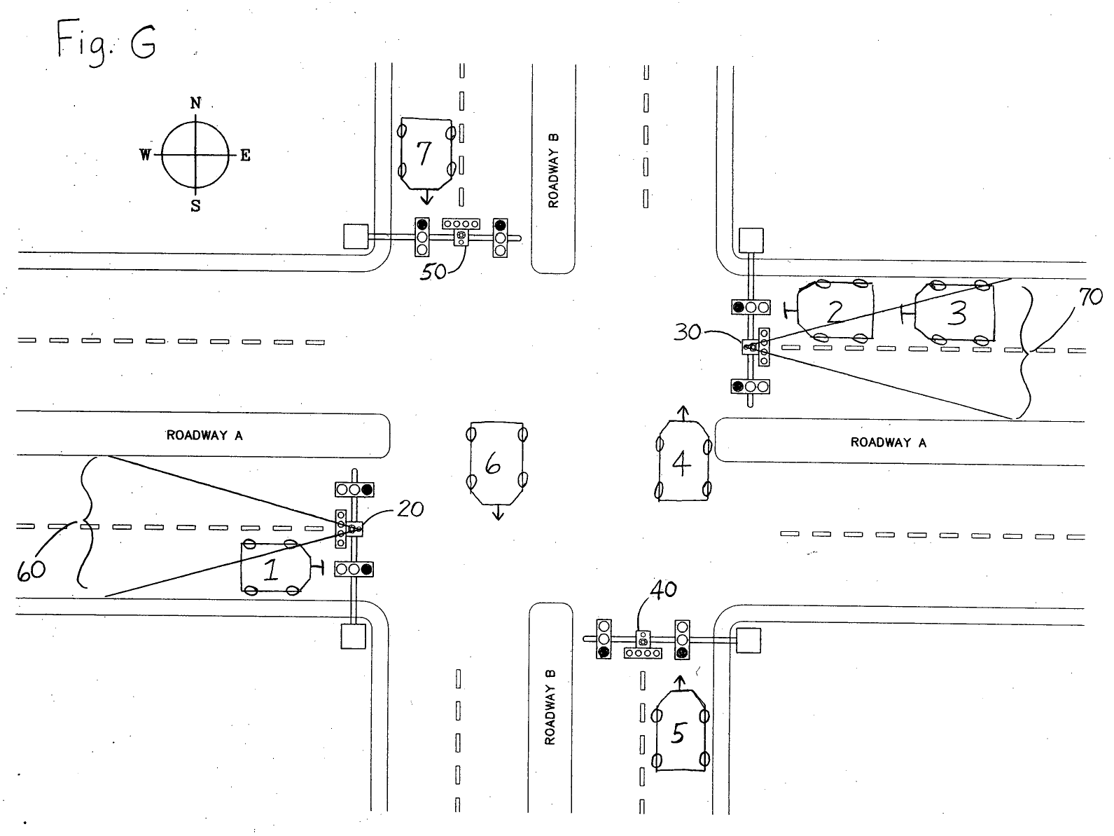

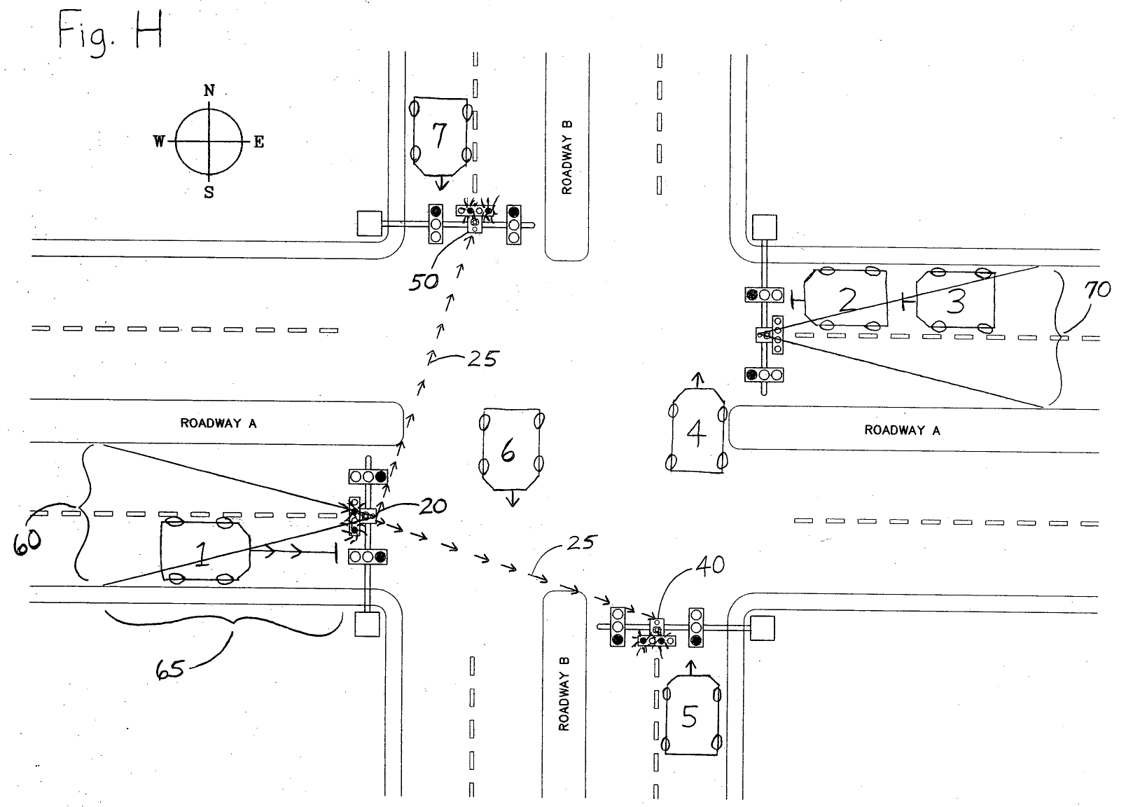

### CROSS-REFERENCE TO RELATED APPLICATIONS

This application claims priority under 35 U.S.C.sctn.119(e) to U.S. Patent Provisional Application No. 60/537,596, filed on Jan. 20, 2004, Title, Vehicle Intersection Early Warning System (VIEWS) is the red light violation prevention and collision avoidance system of this application, the disclosure of which is expressly incorporated by referrence herein in its entirety.

### BACKGROUND OF INVENTION

The present invention relates to signalled controlled roadway intersections and the approaches various companies and inventors, by their system designs, are taking to create and make available in the United States and to other countries around the world an effective system to significantly reduce fatal and non-fatal vehicle accidents due to running red lights and/or to help avoid vehicle collisions within intersections due to said violations at signalled controlled roadway intersections. All designs patented and those pending patent approval to remedy said intersections problems I found utilize many devices or methods such as, sophisticated monitoring devices, computers, various forms of software systems, GIS (Geographical Information System) which is a software design mapping service, GPS (Global Postioning System) which utilizes satelites for tracking location of any GPS equipped objects, digital video cameras, digital photo cameras, methods of altering the traffic light signal time, warning devices both visual and audible, roadway sensors embedded within lane(s) of roadways approaching said intersections, many designs even require additional structures to be erected at said intersections to house some devices and methods all of which is or will be additional costs to municipalities that adopt said systems and most importantly all said designs requiring warning devices, antennas, and/or GPS devices mounted in all motor vehicles will add significant cost to owners of all vehicles either as an option on new vehicles or as a aftermarket kit to be purchased and installed, thereby delaying the true benefit of said designs to achieve the goals of reducing fatal and non-fatal accidents at said roadway intersections saving society billions of dollars in costs due to the results said accidents.

It is the object of the invention in this application to present a system for patent approval that offers a method of preventing red light violations and more particularly inadvertant red light running by motor vehicle operators and avoid motor vehicle collisions due to said violations at signalled controlled roadway intersections. My system design, not requiring complex devices and/or recording methods, embedded roadway sensors, additional housing structures, or devices requiring to be mounted in vehicles and/or to vehicles, only has to be mounted to existing traffic signal arrangement(s), properly aligned according to lane(s) being controlled by traffic signal(s), wired to main signal power source, and connected to traffic light signal output circuit and/or wiring to become fully operational.

### STATEMENT REGARDING FEDERALLY SPONSORED RESEARCH OR DEVELOPMENT

N/A

### DESCRIPTION OF THE RELATED ART

Prior art disclosed deals directly with traffic flows and interactions of motor vehicles taking place as they approach a signal-controlled roadway intersection and flowing through said intersection. All designs utilize methods to receive traffic light signal inputs to establish their mode of operation in:

U.S. Pat. No. 6,624,782, Jocoy, Sep. 23, 2003, System and Method for Avoiding Accidents in Intersections, assigned to Veridian Engineering Inc., requires additional roadway structures, in-vehicle antennas and radar devices, multiple roadway radar units, computer hardware, computer software utilizing GIS (Geographical Information System) and alogorithms, GPS (Global Positioning System), to predict positions of vehicles entering and flowing through signal-controlled roadway intersections to help vehicle avoid collisions.

U.S. Pat. No. 6,516,273, Pierowicz, Feb. 4, 2003, Method and apparatus for determination and warning of potential violation of intersection traffic control devices, assigned to Veridian Engineering Inc., utilizes in-vehicle antennas, warning devices, special vehicle braking over-ride, GIS, GPS, computer hardware and software, a preempt driver controller system, all to provide a method to avoid vehicle collisions at intersections and possible other roadway arrangements.

U.S. Pat. No. 6,281,808, Glier, Aug. 28, 2001, Traffic Light Collision Avoidance System, assigned to Nestor Inc., utilizes digital cameras, video cameras, computer, software program, and inductive loop sensors embedded in the lanes of a roadway to predict a red light violation, delay red light signal(s) and green light signal(s) in order to prevent collisions within an intersection, capture violation, and send proof of violation to court.

U.S. Patent Applications, No. 20030016143, Ghazarian, Jan. 23, 2003, Intersection Collision Avoidance System, No. 20020070880, Dotson, Jun. 13, 2002, and No. 20020008637, Lemelson, Jan. 24, 2002, are current applications for systems or methods of traffic control for collision avoidance of motor vehicles at or within roadway intersections. and all require some form of radio transmitters and/or transceivers within each vehicle, antennas on each vehicle, GPS, computer hardware and software, and some form of additional roadway structure for mounting equipment along the roadway.

All said prior art systems require complicated support devices and operational equipment that in all cases will require automobile manufacturers to install or individuals to have installed in their present vehicles at additional costs to the vehicle owner either as a purchase option or aftermarket installation kit in order for said systems to function and some said art will add substantial costs to municipalities for additional equipment housing structures required for their vehicle monitoring abilities.

The present invention in this application requires no direct additional costs to vehicle owners, no complicated computer hardware and software, no onboard vehicle warning devices, no antennas to be installed on vehicles, no embedded sensor systems in roadways, and no additional structures to be errected at intersections or their additional costs. Considering all said requirements of prior art, the time factor involved in equipping all vehicles so as to offer all vehicle operators the benefits of said traffic light warnings and collision avoidance systems will be many years down the road and will not offer a timely answer to improve saving lives, reducing non-fatal accidents, and significantly reducing the billions of dollars of costs society has to bear each year due to the result of said traffic occurances. The invention in this application will offer timely savings to society due to it's design and ability to function by simply attaching to existing roadway intersection traffic signal arrangement and connecting to the main traffic signal controller.

### BRIEF DESCRIPTION OF PREFERRED EMBODIMENT

Illustration 1 page 12, Fig. A, shows preferred embodiment, two part housing, containing visual and audible warning components, vehicle speed monitoring component (shown outward on embodiment), DC (Direct Current) transformer, radio transceiver, antenna, a bi-modal electronic system controller, all system wiring (not shown), all enclosed within said embodiment allowing the complete system to function as a single operating entity when attached to a roadway traffic signal arrangement, depicted in Illustration 1, Fig.'s B, profile view of embodiment attached to a cross-sectional view of traffic arm, C arm extended over roadway, D depicting arm extended over roadway with left turn lane signals, and E cable mounted and all wired into the main traffic light signal controller.

Warning components consist of four 4″ (four inch) LED (light emiting diode) type warning lights (two yellow, two red) for the visual warning and a high decibel horn for the audible warning having a three to five second timed warning. Where vehicle traffic turning lanes are utilized a more compact verson of this system only utilizes two visual warning lights, one red and one yellow, same timed warning duration as shown already Illustration 1, Fig. D, left turning lane configuration.

Vehicle approach-speed monitoring component and/or components consist of a RADAR (Radio Distancing and Ranging) speed detector and/or LIDAR (Light Distancing and Ranging) speed detector. Determining the type detector utilized will be established by traffic lane designs and control requirements. RADAR speed detectors can be modified to monitor wider areas or multiple lanes of traffic whereas LIDAR would be utilized for more specific lane monitoring such as turn lanes.

The DC transformer will be utilized where traffic signal light controllers operate on AC (Alternating Current) only.

Radio transceiver, a transmitter and a receiver, operates in the Gigahertz frequency range due to these frequencies operating reliably under high noise conditions and having less radio interference problems by other radio frequency devices. The antenna is a short external type mounted at the highest point of the preferred embodiment.

Electronic circuitry component is the system contoller and is a two phase (bi-modal) operation, Alpha mode and Beta mode. Alpha mode (red light mode) is activated by the yellow and/or red light traffic signal received from the main traffic light signal controller where the speed monitor(s) are activated to measure the deceleration rate of vehicles approaching a red light stopping point. Beta mode (green light mode) speed detector(s) are deactivated and the receive (RF signal input) side of the radio transceiver functions to monitor signals from other operating units in the Alpha mode at same intersection. The electronic circuit component also processes various information it receives from either modes of operation to initiate the visual and audible warnings and controlling the radio transceiver to function either in the transmit or receiving stage of operation.

The preferred embodiment, will operate as a single entity or in combinations of two or more, will monitor vehicles approaching a signal-controlled roadway intersection and depending upon the traffic light signal being received from the main traffic light signal controller will, in the Alpha mode measure any vehicle's approach speed to a red light's stopping point and if vehicle(s) display intent of not slowing or stopping, within a red light signals speed measurement zone, by vehicle(s) excessive speed approaching said red light stopping point, operators of said vehicle(s) will receive multiple flashing red warning lights at preset alternating sequential flash rates and a prominent horn blast to gain the vehicle operator's and/or multiple vehicle operators attention to slow and stop immediately and at the instant the warning signals are activated, the radio transceiver is transmitting to any other systems operating in Beta mode, to activate their multiple flashing yellow warning lights with preset alternating sequential flash rates and prominent horn blast, signalling vehicle operator(s) receiving a green light signal to slow immediately and look for possible danger from vehicle(s) running a red light at the opposing intersecting lane(s) and when clear proceed as normal. In Summary, Alpha mode operates to prevent red light violations while Beta mode operates to warn operators receiving a green light signal to take immediate actions to look for possible danger from vehicle(s) running a red light against their traffic flow, therefore the Red Light Violation Prevention and Collision Avoidance System offers signalized roadway intersection warnings to both flows of traffic when activated.

Figure E, page 13, shows a block diagram of bi-modal electronic circuit controller of preferred embodiment showing flow chart operation. Given that, AC power is connected to system and system is wired into the main traffic signal controller, the system is now powered throughout the circuitry including the monitoring and warning components by the DC power transformer 5, main traffic signal controller activates system operation by yellow signal 6 entering system controller to a time-delayed circuit 7 which delays the actual activation of the Alpha mode operation of the controller by approximately 2 to 3 seconds, this prevents premature activation of the vehicle approach speed monitoring components during the first seconds of the yellow light signal which by state law allows a vehicle operator to continue through a yellow traffic signal as long as they are have not received red light signal entering the roadway intersection. Yellow signal is received from time delay circuit 7 to activate Alpha mode operation 8 which initiates monitor(s) activating circuit 9 actuating speed monitoring RADAR/LIDAR component(s) 10. Red traffic signal 11, when activated, maintains the Alpha mode controller 8 in the vehicle approach speed monitoring phase of operation. When green traffic signal 12 is activated by the main traffic signal controller, Alpha mode operation 8 is deactivated and Beta mode operation 13 is activated initiating receiver activation circuit 14 which activates the receiving phase (input phase) of radio transceiver 15 which monitors for any output signals coming from units operating in the Alpha phase at opposing intersecting traffic signal arrangements, therefore the alternating traffic signals, yellow/red/green, from the main traffic signal controller maintain the bi-modal controller in either the Alpha or Beta modes of operation.

Figure F, page 14, is same block diagram as Fig. E showing flow chart in the Alpha mode monitoring vehicle traffic approaching a red light signal at an intersection signal arrangement. Red signal 11 is received by Alpha mode 8 and directed to monitor activation circuit 9 activating speed monitor 10. Vehicle(s) approach red traffic signal, displaying intent of not slowing and/or stopping for said light, detected by monitor 10 measuring vehicle(s) excessive speed within speed deceleration zone of roadway, monitor(s) will initiate a violation signal out 16 to monitor input processor 17 initiating activation of visual warning circuit 18 to actuate red warning lights 20 and activating audible warning circuit 19 by same violation signal 16 is actuating audible warning device 21 by which utilizing both warnings devices, visual alternating sequential flashing LED red lights and high decibel horn, will gain attention of violating vehicle(s) operator(s) to get them to slow and stop immediately before running the red traffic signal. All said warning units operating on traffic signal arrangements at opposing intersecting traffic lane(s) are operating by control of green input signal 12 from the main traffic signal controller directing said units to function in Beta mode 22 activating receiver 24 to monitor for signal output from Alpha units, therefore circuit control signals 18 and 19 in Alpha mode units have also initiated input signal 23 to radio transceiver 24 of the Alpha unit initiating a RF output signal 25 by way of antenna 26 to Beta mode units operating at said opposing intersecting traffic signal arrangements signalling the RF transceiver 24 of said units to initiate output signal 25 to warning lights activation circuit 27, to actuate yellow warning lights 29 and to activate circuit 28 to actuate audible warning device 21 by which utilizing both warning devices, visual alternating sequential flashing LED yellow lights and a high decible horn, will gain the attention of vehicle operators receiving a green traffic signal to slow immediately and look for possible danger entering intersection from the opposing intersecting red light lane(s) and when clear proceed normally. In summary, the function of this invention is constantly changing between modes of operation by signal input of the main traffic signal light controller to each unit operating at a particular signal-controlled roadway intersection.

### DETAILED DESCRIPTIOIN OF INVENTION

Figure G, page 15, illustrates roadways A and B intersecting at a traffic signal controlled intersection utilizing standardized Department of Transportation signalling (red light top, yellow light middle, green light bottom, and arranged at vehicle lane(s) stopping point before intersection) for purposes of explanation. Vehicle 1 eastbound and vehicles 2 and 3 westbound have fully stopped for the red light in their respective lanes and preferred embodiments 20 and 30, functioning in the Apha mode, are monitoring vehicle approach speeds by speed monitor beams 60 and 70 respectfully, while vehicles 4 and 5 northbound and vehicles 6 and 7 southbound are receiving the green light in their respective lanes and preferred embodiments 40 and 50 respectfully, functioning in the Beta mode, are monitoring for a violation RF transmission signal from preferred embodiments 20 and 30 when activated due to a violation signal from either embodiment. No violation is detected therefore northbound and southbound traffic lanes are flowing into and through intersection without incident or warnings from embodiments 20 and 30. Figure H, page 16, illustrates same roadway intersection and vehicle traffic as Fig. G except vehicle 1 eastbound approaching red traffic signal for eastbound lanes has entered speed measurement zone 65 and displaying an intent of not slowing to stop due to said vehicle's excessive speed within measurement zone 65 monitored by speed monitor beam 60 of preferred embodiment 20, visual warning (two LED alternating sequencially flashing red lights) and an audible warning (high decibel horn) of preferred embodiment 20 is activated (three to five second duration) as violation vehicle 1 approaches eastbound traffic signal, vehicle(s) operator's attention is gained by said visual and audible warnings establishing the operators attention back to red traffic signal therefore vehicle 1 slows immediately to a quick stop before running the red light. The same instant vehicle 1 is receiving warnings preferred embodiment 20 is also signalling by RF signal 25 to preferred embodiments 40 and 50 at their respective traffic flow lanes, receiving a green light signal, to activate their warnings (three to five second duration), a visual warning (two LED alternating sequencially flashing yellow lights) and audible warning (high decible horn), gaining operators attention for vehicles 5 and 7, which have not entered intersection at this point, to slow immediately and look for possible danger from vehicle(s) running red light(s) from opposing intersecting red light traffic lane(s) and when intersection danger is clear proceed normally. The preferred embodiment operations alternate between Alpha and Beta modes as dictated by signal input from the main traffic signal light controller as explained in description of preferred embodiment.

### SUMMARY OF INVENTION

A system, utilizing speed detection, visual warning, audible warning, radio transceiver, and a system operation controller, functioning as a self-contained operational entity either alone or in groups of two or more when mounted on a traffic signal-light arrangement(s) and connected to traffic light signals from main traffic light signal controller, for providing a methods of preventing red light violations and/or inadvertant red light violations by motor vehicle operators due to attention and/or inattention by utilizing said detection to monitor vehicle speed and said warnings to gain or regain vehicle operators attenton to a red light signal to slow and stop if operator(s) displays intent of not slowing and/or stopping as vehicle approaches a red light signal and avoid motor vehicle collisions within the intersection of said violations by utilizing said warnings at motor vehicle operators receiving a green light signal at the opposing intersecting traffic lane(s) to slow immediately and look for danger entering the intersection from opposing intersecting red light lane(s) avoiding a possible vehicle collision if said violation vehicle refuses to stop for a red light at said signal-controlled roadway intersections.

1. A system, that provides a method(s) of early detection and methods of early warning, to motor vehicle operators of at least one traffic lane receiving a red traffic light signal, to prevent red light violations, intentionally and/or unintentionally, at signal-controlled roadway intersections,
and said system will provide said methods of early warning to motor vehicle operators receiving a green traffic light signal at the opposing intersecting traffic lane(s), to avoid motor vehicle collisions within same said roadway intersections, due to same said red light violations.

2. The system of claim 1, a self-contained operational entity, comprising of:
at least one detection method,
visual warning methods,
an audible warning method,
a bi-modal electronic system controller,
a radio transceiver and antenna,
a DC (direct current) transformer,
all intergrated within a housing(s) capable of functioning as a single entity and/or in combinations of two or more when connected to a main traffic signal controller and said controller's power source and mounted on said intersection's traffic signal arrangement to prevent said red light violations and avoid said vehicle collisions within said roadway intersections.

3. The design of system in claim 1 and 2, having at least one detection method, RADAR and/or LIDAR speed detector(s), for detecting a motor vehicle(s) deceleration speed as 3 said vehicle approaches said red light within a preset speed deceleration measurement zone for determining said vehicle(s) red light violation probability.

4. The design of system in claim 1 and 2, having visual warning methods consisting of:
at least one red light, warning with multiple flashes of light per minute, to gain and/or regain a motor vehicle operator(s) attention to a red light signal(s) when said operator(s) display intent to violate said red signal due to said operator(s) vehicle(s) approach speed to said red signal because of said operator(s) attention and/or inattention to said signal(s), to prevent said red light violations,
and at least one yellow light, warning with multiple flashes of light per minute, to gain a motor vehicle(s) operator(s) attention receiving a green light signal(s) at opposing intersecting traffic lane(s) of said violations to slow immediately and look for possible danger from a vehicle(s) running said red light thereby avoiding motor vehicle collisions due to said violations within said intersection(s).

5. The design of system in claim 1 and 2, having an audible warning method, consisting of a high decibel pulsating horn, to gain and/or regain a motor vehicle operator(s) attention to a red light signal(s) when said operator(s) display intent to violate said red signal(s) due to said operator(s) vehicle(s) approach speed to said signal(s) because of said operator(s) attention and/or inattention to said signal(s) to prevent said red light violations,
and warning with same said horn to gain a motor vehicle(s) operator(s) attention receiving a green light signal(s) at opposing intersecting traffic lane(s) to slow immediately and look for possible danger from a vehicle(s) running said red light thereby avoiding motor vehicle collisions due to said violations within said intersections.

6. The design of system in claim 1 and 2, having a bi-modal electronic system controller that utilizes traffic light input signals from the main traffic signal-light controller to initiate operations of said system to function in two distinct modes of operation, Alpha mode (yellow and/or red light monitoring mode) and Beta mode (green light monitoring mode), controlling system operations for initiating and actuating all functions for preventing said red light violations and avoiding said collisions within said intersections.

7. The design of system in claim 1 and 2, having a radio transceiver, a transmitter and receiver, operating in the Gigahertz frequency range due to said frequency having less signal interference from road noises and other radio frequency controlled devices operating in and around said intersection's location, to transmit violation signals from Alpha mode operating systems when said red light violation occurs to Beta mode operating systems at said opposing intersecting traffic lane(s) signal-controlled traffic light arrangements to initiate their said warnings to motor vehicle operator(s) at said opposing intersecting traffic lane(s) to avoid motor vehicle collisions due to said red light violations within said intersections.

8. The design of system in claim 1 and 2, having a DC (direct current) transformer enables said system to function on DC power, where DC power is not available, due to all said component devices requiring low voltage DC to function as said detection and said warning system.

9. The design of system in claim 1 and 2, having all said components intergrated and comprised within a housing(s) allows said system to become said self-contained operational entity able to monitor, detect, warn, and communicate in Alpha mode to said entities operating in Beta mode at said opposing intersecting lane(s) to receive RF signal from Alpha mode systems to activate and give said warnings to said opposing intersecting vehicle operator(s) to look for said possible danger entering said intersection due to said violations and avoid possible said collisions.

10. The system of claim 2, a self-contained operational entity which allows said system to be utilized on various traffic signal light arrangements, arm mounted signal extending over a roadway intersection, single pole mounted signal adjacent to a roadway intersection, or cable mounted signal hanging across a roadway intersection, to provide said detection and said warnings to said motor vehicle operator(s) to prevent said red light violations and to provide said warnings to motor vehicle operator(s) receiving a said green light signal at said opposing intersecting lane(s) to avoid said motor vehicle collisions due to said red light violations within said intersections.

11. The system design of claim 9, having all said intergrated components and comprised within a housing(s) is not limited in it's scope of housing designs in that it can be segmented by seperating the detection method(s) from the warning methods and mount said devices at various strategic locations on said traffic signal arrangement(s) and controlled by said system controller to provide said detection and said warnings to prevent said violations and provide said warnings to said vehicle operator(s) at said opposing intersecting lane(s) to avoid motor vehicle collisions with said violators within said intersections.
